(19) United States
(12) Patent Application Publication
(10) Pub. No.: US 2002/0005344 A1
(43) Pub. Date: Jan. 17, 2002

(54) PROCESS FOR FRACTIONATING VISCOUS SILICONES

(76) Inventors: JURGEN HEIDLAS, TROSTBERG (DE); JOACHIM VON SEYERL, SEEON (DE)

Correspondence Address: FULBRIGHT & JAWORSKI, LLP, 666 FIFTH AVE, NEW YORK, NY, 10103-3198, US

(21) Appl. No.: 09/319,664

(22) PCT Filed: Dec. 24, 1997
(86) PCT No.: PCT/EP97/07301

(30) Foreign Application Priority Data
Dec. 27, 1996 (DE) 196 54 488.2

(51) Int. Cl. B01D 3/34; C08G 77/36

(52) U.S. Cl. 203/49; 203/68; 203/70; 203/91; 556/466; 106/287.11; 106/287.14

(57) ABSTRACT

For the fractionation of viscous silicones, oily or polymeric diorganosilicones with a chain length of between 2 and 10 000 are separated into a top and a bottom product, preferably continuously in an extracting column, using compressed hydrocarbons such as ethane, propane and n- or i-butane, or mixtures thereof, at temperatures of between 25 and 250° C., pressures of between 20 and 500 bar and a gas density >160 kg/m³. To avoid viscosity problems, either an organic solvent in the form of a C₅₋₈ alkane or up to 85 wt. % of the compressed gas (mixture) can be added to the starting materials prior to fractionation. With this process, high-quality viscous silicone fractions are obtained, which have a chain length of 200 to 10 000 and/or a viscosity of 100 to 500 000 mPas, and whose total oligomer content D4 to D20 is less than 0.05 wt. %.

The subject matter of this invention is a process for the fractionation of viscous silicones with compressed gaseous hydrocarbons, and the thus-obtained fractionated viscous silicones.

The term “viscous silicones” is to be understood in this context to comprise both silicone oils and silicone polymers whose degree of crosslinking still permits certain viscous properties or which, according to the process of the invention, can be brought into the viscous (pumpable) state.

Silicones or silicone rubber systems have found many fields of application during the last few decades, and on account of their hitherto unsurpassed properties, serve manifold purposes in typical areas such as mold-making, biomedical engineering, the dental sector, electrical installations and the leather industry, but also in the household and D.I.Y. areas.

Silicones are based on their polymeric or oily main components (viscous silicones), to which the typical properties are imparted by mixing with curing agents, catalysts, fillers, pigments and other auxiliaries. The main components have the silicon-oxygen backbone typical of silicones, in which organic radicals such as methyl but also phenyl groups are bound to the silicon atom. The length of the chain has a direct influence on the viscosity of the polymer or the oils, and may assume values in excess of 10 000; the number and type of substituents which, besides methyl and phenyl groups, are incorporated in the chain molecule, largely determine the excellent properties, such as elasticity, temperature and solvent resistance, gas permeability, and resistance to radiation. In practice, the above-mentioned basic mixtures usually cure according to the principles of addition or condensation crosslinking. Both types of reaction result in three-dimensional crosslinking which can be controlled very selectively, allowing the degree of elasticity to be adjusted extremely accurately.

Viscous silicones are still synthesized according to the Rochow process, in which, under catalytic influence, silicon is reacted with methyl chloride to form mainly dimethylsilyl dichloride and small proportions of trimethylsilyl monochloride and monomethylsilyl trichloride. By way of a methanolysis of these intermediate products to form the corresponding silanols, one finally obtains the desired siloxanes, which may be cyclic or linear. For the application fields mentioned, the cyclic, so-called “D4” siloxane is currently the most important starting product. As a rule, this is converted by means of a ring-like polymerisation, during which it undergoes hydrolysis, into special, long-chain oils, for example the Baysilore® oils of the company Bayer AG. The cyclic oligomers are characterized by the number of their monomeric ring members, eg, D3, D4, D20, which is an indication of the size of the oligomer rings.

The hydrolysis described above, however, has the disadvantage that it is an equilibrium reaction, in which cyclic compounds of the type D4, but also D3, D5 or D6 remain in the raw oil in proportions of approximately 12 to 18 wt. %. This has a negative influence both on the properties and also, in particular, on the quality features of these principal components, which are the most important ones for the rubber systems.

Until now, the viscous silicones were purified—ie, the cyclic oligomers removed—by heating for several hours under vacuum at approximately 200° C. This allows the proportion of volatile components to be reduced to less than 0.5%. However, rings with higher numbers of members (D>10) cannot be removed by this method, and remain in the starting products in a proportion of 2 to 3%.

This presents a problem in so far as various applications—some of them very special—of silicone rubber systems require markedly lower proportions of volatiles, namely <0.1%. Examples of such applications are cable connectors, where the compulsory resistance values can only be achieved with very small proportions of volatiles, or the fields of technical parts manufacturing and the so-called “food oils”, or the liquid-silicone components market.

Attempts have been made in the past to remove the undesired cyclic oligomers from polydimethyl siloxanes with supercritical carbon dioxide (“Processing of polymers with Supercritical Fluids”, V. Krukonis, Polymer News, 1985, Vol. 11, 7-16). However, despite the technical prerequisites for obtaining an acceptable degree of solubility (eg, high pressures), the results did not meet the expectations due to the poor lipophilic and polar properties of compressed CO₂.

In Polymer Preprints Vol. 31, No. 1, 1990, p. 673-674, a process is described, among others, for the fractionation of polymers and in particular of diorganosiloxanes using supercritical ethane as extraction medium. The disadvantage of using ethane as supercritical extraction medium must be seen in the fact that this usually involves extensive safety measures and that, on account of the low ethane gas content, the process generally does not reach the required level of efficiency. This makes it unsuitable for use on an industrial scale. Other hydrocarbons that might be used as extracting media for diorganosiloxanes are not disclosed or rendered obvious.

The object of this invention is thus to overcome the described shortcomings of the prior art by developing a process for the fractionation of viscous silicones with compressed gases, which has the advantage of permitting the undesirable cyclic-oligomer content to be reduced to a tolerable level.

This object is established according to the invention by conducting the fractionation with a compressed, gaseous hydrocarbon containing 3 to 4 carbon atoms at a processing temperature between 25 and 250° C. and under a processing pressure of between 20 and 500 bar, the gas having a density of >160 kg/m³.

Surprisingly, it was found in practice that with this process, the overall proportion of cyclic oligomers up to D20 can be reduced even well below the required level of 0.1 wt. %, and that, in addition to simply purifying the viscous silicones in this way, it is possible, by means of selective fractionation, to obtain new qualities of polymeric silicones and silicone oils. This was not to be expected alone on the basis of the problem to be solved.

As starting material for the process of the invention, oily and/or polymeric diorganosilicones with a chain length of between 2 and 10 000 are used, which can also be substituted. Preferably, polydimethyl silicones, polymethylphenyl silicones, polydiphenyl silicones and silicones substituted with organohalides, especially polyorganofluorosilicones, are used, and mixtures thereof. This means that, all homogeneous or heterogeneous, chain-like or crosslinked polydisperse silicones which have hitherto been relevant for technical applications are suitable for the process; the substituent distribution can be regular or randomized, and the molecular-weight distribution of the oils and polymers can be fully arbitrary, which increases the scope of the process even more.

As extraction media, the compressed, gaseous hydrocarbons propane and n- or i-butane are used, and mixtures thereof, which have proved to be especially suitable for the intended applications on account of their lipophilic properties. The higher-molecular components of the starting materials are insoluble in these extraction media under the conditions of the invention, while the lower-molecular, volatile components dissolve very well. Despite this, it has proved highly expedient in special cases if, for example to cut costs, a mixture according to the invention and consisting of propane and a maximum of 25 wt. % butane is used, or if, for reasons dictated by the process technology, propane together with a maximum proportion of 50 wt. % dimethyl ether is used, which serves as entraining agent in this case.

According to the invention, the fractionation is carried out continuously in an extractive column, using the countercurrent principle. In cases where the fractionation is to be performed on a starting material which is in the form of a semi-finished and/or shaped product (cable insulations, connectors, plastic mouldings for medical applications, etc.) the process can also be conducted batchwise, although wide use of this procedure is limited by the fact that the starting material must have a certain minimum viscosity for the fractionating process.

By way of adjusting the gas density through selection of the processing parameters pressure and temperature in the range of the invention, the starting product can be fractionated into a bottom product and a top product. The pressure and the temperature (which determine the gas density) depend for one on the type of starting material, and for the other on the desired aim and the quantity distribution of the fractionation. The fractionation is technically easy to control; for example, at constant processing pressure, increasing the processing temperature will lead to a reduction in the ratio of top to bottom products, and vice versa.

To achieve better separation of the starting materials into a top and a bottom product, it has proved beneficial according to the invention to adjust the temperature gradient in the extracting column such that the temperature increases towards the top. The maximum temperature difference should not exceed 20° C.; this makes it possible to isolate the often undesirable cyclic oligomers as top products, while the purified viscous silicones are collected with only very small losses as bottom product.

Based on the above principle, the process has manifold uses for the fractionation of viscous silicones. In principle, it is always possible to separate the starting material arbitrarily into a top product of low viscosity and a lesser degree of polymerization, and a bottom product of higher viscosity and a higher degree of polymerization. It thus follows that in all fractionations, the cyclic oligomers are collected as top product. When the process is used industrially, there is in principle the possibility of connecting up a plurality of fractionating columns in series and thus obtaining a number of selective silicone fractions in one process.

As was already explained in connection with the batchwise processing variant, the starting materials must have a certain minimum viscosity if the fractionation is to be successful. In cases where the viscosities of the starting materials are not low enough, it has therefore proved by all means useful, prior to the actual fractionation, to add 1 to 50 wt. % of an organic solvent to the oils or polymers in question in order to reduce their viscosities. According to the invention, these solvents are preferably n- or i-alkanes with 5 to 8 carbon atoms, short-chain ketones with 1 to 5 carbon atoms, preferably acetone or butanone-2, or short-chain primary or secondary alcohols with 1 to 4 carbon atoms. In this case, provision is made according to the invention for recovery of the organic solvent in question from the top product; for one thing, this makes for economical processing in terms of resource consumption; for another, in cases where the oligomers concentrated in the top product are also to be regarded as qualitatively valuable products, it prevents impairment of the quality by remaining solvent. The viscosity of the starting materials can also be reduced—again prior to fractionation - by dissolving the starting materials in 1 to 85 wt. % of the compressed gas (mixture).

The versatility of this process is to be seen not least in the fact that with the fractionation according to the invention, viscous silicones can be obtained which have a chain length of 200 to 10 000, or with a viscosity of 100 to 500 000 mPas. Obtaining a viscosity of 500 000 is all the more astonishing since in this viscosity range, the silicones almost cease to exhibit any free-flow properties, and with regard to their fractionating properties, approximate solids.

In any event, this process makes it possible to obtain fractionated, viscous silicones as bottom products, which, according to the invention, have a total oligomer content D4 to D20 of less than 0.05 wt. %. The upper limit for the total oligomer content is of course dictated exclusively by economic considerations.

The following examples serve to illustrate the advantages of the process according to the invention:

### EXAMPLES

Examples

| | | | | | |
|---|---|---|---|---|---|
| Example 1 | Example 2 | Comp. example 3 | Example 4 | Example 5 | Example 6 |

| | |
|---|---|
| Starting material: | Polydimethylsiloxane oils |

| | Silopren ® U10 | Silopren ® U65 | Silopren ® U10 | Silopren ® U65 | Silopren ® U65 | Silopren ® U65 |
|---|---|---|---|---|---|---|
| | Registered marks of Bayer AG, Leverkusen | | | | | |
| Viscosity [mPas]: | 10 000 | 65 000 | 10 000 | 65 000 | 65 000 | 65 000 |
| Process | | | | | | |
| conditions: | | | | | | |
| Extraction | Propane/butane | Propane | Ethane | Butane | Propane | Propane |
| medium: | 75/25 | | | | | |
| Column pressure | 45 | 42 | 130 | 40 | 42 | 42 |
| [bar]: | | | | | | |
| Column | 98 | 93 | 50 | 125 | 80 | 75 |
| temperature [° C.] | | | | | | |
| Gas density | Approx. 330 | Approx. 320 | Approx. 290 | Approx. 390 | Approx. 380 | Approx. 400 |
| [kg/m³]: | | | | | | |
| Feed [wt. %]: | 20 hexane | 40 hexane | 20 hexane | 40 hexane | 5 propane | 5 propane |
| Solvent/feed | Approx. 5% | Approx. 4% | Approx. 2% | Approx. 3% | Approx. 5% | Approx. 5% |
| ratio: | | | | | | |
| Result: | | | | | | |
| Amount of bottom | 475 g | 300 g | 150 g | 135 g | 300 g | 100 g |
| product (colour- | | | | | | |
| less): | | | | | | |
| Amount of top | 109 g | 30 g | 10 g | 65 g | 300 g | 500 g |
| product | | | | | | |
| (yellowish): | | | | | | |
| Ratio bottom/top | 81:19 | 90:10 | 93:7 | 67:33 | 50:50 | 10:50 |
| product: | | | | | | |
| Total oligomer | 0.01% | 0.02% | 0.04% | 0.03% | 0.02% | 0.02% |
| content (D4-D20) | | | | | | |
| in bottom product | | | | | | |
| [HPLC]: | | | | | | |
| Viscosity of the | Approx. 12 000 | Approx. 75 000 | Approx. 11 000 | Approx. 85 000 | Approx. 90 000 | Approx. 105 000 |
| bottom product | | | | | | |
| [mPas]: | | | | | | |

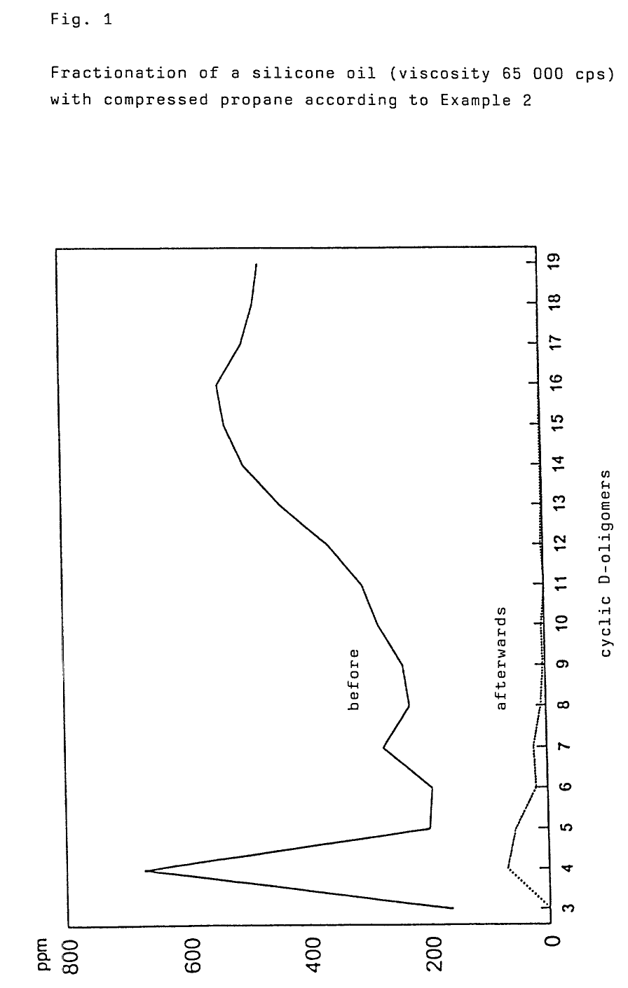

FIG. 1 illustrates the reduction in cyclic D4- D20 oligomers as a result of fractionating the starting material of Example 2 in a process according to the invention.

1. A process for the fractionation of oily and polymeric diorganosilicones, which have a chain length of between 2 and 10 000 and may be substituted, with compressed gases, characterized in that the fractionation is conducted with a compressed, gaseous hydrocarbon having 3 or 4 carbon atoms at processing temperatures of between 25 and 250° C. and under processing pressures of between 20 and 500 bar, the gas having a density of >160 kg/m³.

2. The process of claim 1, characterized in that as starting material, polydimethyl silicones, polymethylphenyl silicones, polydiphenyl silicones and silicones substituted with organohalides, especially polyorganofluorosilicones, are used, and mixtures thereof.

3. A process according to claim 1 or 2, characterized in that as compressed, gaseous hydrocarbon, propane, n- or i-butane or mixtures thereof are used.

4. The process of claim 3, characterized in that the mixture consists of propane and a maximum of 25 wt. % butane.

5. The process of claim 3, characterized in that propane together with a maximum proportion of 50 wt. % dimethyl ether is used.

6. A process according to claims 1 to 5, characterized in that the fractionation is carried out continuously in an extractive column.

7. A process according to claims 1 to 6, characterized in that the fractionation is conducted according to the countercurrent principle.

8. A process according to claims 1 to 7, characterized in that a temperature gradient is applied to the extracting column, with the temperature increasing towards the top of the column.

9. A process according to claims 1 to 8, characterized in that prior to the fractionation, an organic solvent is added to the starting materials in order to lower their viscosity, said solvent being added in an amount of 1 to 50 wt. % and being selected from the branched or unbranched n- or i-alkane series with 5 to 8 carbon atoms, the short-chain ketone series with 1 to 5 carbon atoms, preferably acetone or butanone-2, or the short-chain, primary or secondary alcohol series with 1 to 4 carbon atoms.

10. The process of claim 9, characterized in that the organic solvent is recovered from the top product.

11. A process according to claims 1 to 8, characterized in that prior to the fractionation, the starting materials are dissolved in 1 to 85 wt. % of the compressed gas (mixture) in order to reduce their viscosity.

12. Fractionated oily and polymeric silicones, which may be substituted and are produced according to claims 1 to 11, characterized in having a chain length of 200 to 10 000 and a total oligomer content D4 to D20<0.05 wt. %.

13. Fractionated oily and polymeric silicones, which may be substituted and are produced according to claims 1 to 11, characterized in having a viscosity of 100 to 500 000 mPas and a total oligomer content D4 to D20<0.05 wt. %.
